(19) United States
(12) Patent Application Publication
(10) Pub. No.: US 2019/0349705 A9
(43) Pub. Date: Nov. 14, 2019

(54) GRAPHICAL USER INTERFACE TO ADAPT VIRTUALIZER SWEET SPOT

(71) Applicant: DTS, Inc., Calabasas, CA (US)

(72) Inventors: Guangji Shi, San Jose, CA (US); Themis George Katsianos, Highland, CA (US); David Cortes Provencio, Oak Park, CA (US); Anthony Hand, San Jose, CA (US); Leslie Jensen-Link, Roswell, GA (US); Daekyoung Noh, Huntington Beach, CA (US); Vlad Ionut Ursachi, Santa Clara, CA (US)

(21) Appl. No.: 16/228,740

(22) Filed: Dec. 20, 2018

Related U.S. Application Data
(63) Continuation-in-part of application No. 16/119,368, filed on Aug. 31, 2018.
(60) Provisional application No. 62/553,453, filed on Sep. 1, 2017.
(60) Provisional application No. 62/613,982, filed on Jan. 5, 2018.

(51) Int. Cl. H04S 7/00; G06F 3/16

(52) U.S. Cl. CPC H04S 7/40; G06F 3/167; H04S 7/301

(57) ABSTRACT

Systems and methods discussed herein can provide three-dimensional audio virtualization with sweet spot adaptation. In an example, an audio processor circuit can be used to update audio signals for sweet spot adaptation based on user information input to a graphical user interface information about a listener position in a listening environment.

### CLAIM OF PRIORITY

This patent application is a continuation-in-part of U.S. patent application Ser. No. 16/119,368, filed on Aug. 31, 2018, which claims priority to U.S. Patent Application No. 62/553,453, filed on Sep. 1, 2017.

### BACKGROUND

Audio plays a significant role in providing a content-rich multimedia experience in consumer electronics. The scalability and mobility of consumer electronic devices along with the growth of wireless connectivity provides users with instant access to content. Various audio reproduction systems can be used for playback over headphones or loudspeakers. In some examples, audio program content can include more than a stereo pair of audio signals, such as including surround sound or other multiple-channel configurations.

A conventional audio reproduction system can receive digital or analog audio source signal information from various audio or audio/video sources, such as a CD player, a TV tuner, a handheld media player, or the like. The audio reproduction system can include a home theater receiver or an automotive audio system dedicated to the selection, processing, and routing of broadcast audio and/or video signals. Audio output signals can be processed and output for playback over a speaker system. Such output signals can be two-channel signals sent to headphones or a pair of frontal loudspeakers, or multi-channel signals for surround sound playback. For surround sound playback, the audio reproduction system may include a multichannel decoder.

The audio reproduction system can further include processing equipment such as analog-to-digital converters for connecting analog audio sources, or digital audio input interfaces. The audio reproduction system may include a digital signal processor for processing audio signals, as well as digital-to-analog converters and signal amplifiers for converting the processed output signals to electrical signals sent to the transducers. The loudspeakers can be arranged in a variety of configurations as determined by various applications. Loudspeakers, for example, can be stand-alone units or can be incorporated in a device, such as in the case of consumer electronics such as a television set, laptop computer, hand held stereo, or the like. Due to technical and physical constraints, audio playback can be compromised or limited in such devices. Such limitations can be particularly evident in electronic devices having physical constraints where speakers are narrowly spaced apart, such as in laptops and other compact mobile devices. To address such audio constraints, various audio processing methods are used for reproducing two-channel or multi-channel audio signals over a pair of headphones or a pair of loudspeakers. Such methods include compelling spatial enhancement effects to improve the listener's experience.

Various techniques have been proposed for implementing audio signal processing based on Head-Related Transfer Function (HRTF) filtering, such as for three-dimensional audio reproduction using headphones or loudspeakers. In some examples, the techniques are used for reproducing virtual loudspeakers, such as can be localized in a horizontal plane with respect to a listener or located at an elevated position with respect to the listener. To reduce horizontal localization artifacts for listener positions away from a “sweet spot” in a loudspeaker-based system, various filters can be applied to restrict the effect to lower frequencies.

Audio signal processing can be performed at least in part using an audio virtualizer. An audio virtualizer can include a system, or portion of a system, that provides a listener with a three-dimensional (3D) audio listening experience using at least two loudspeakers. However, such a virtualized 3D audio listening experience can be limited to a relatively small area or specific region in a playback environment, commonly referred to as an audio sweet spot, where the 3D effect is most impactful on the listener. In other words, 3D audio virtualization over loudspeakers is generally most compelling for a listener located at the sweet spot. When the listener is outside of the sweet spot, the listener experiences inaccurate localization of sound sources and unnatural coloration of the audio signal. Thus, the 3D audio listening experience is compromised or degraded for a listener outside of the sweet spot.

### SUMMARY

In one aspect, an example system is provided for adjusting one or more received audio signals based on user input indicating a sweet spot location relative to a speaker. A graphic display circuit causes display of a sweet spot graphic at a display screen location in relation to a display screen location of a graphic representing a speaker location, based upon user input selecting the sweet spot graphic display screen location. A sweet spot location positioning circuit determines a sweet spot location in relation to the speaker location, based at least in part upon the speaker location and the user-selected sweet spot graphic display screen location in relation to the display screen location of the graphic representing the speaker location. An audio processor circuit is configured to generate one or more adjusted audio signals based at least in part upon the one or more received audio signals and an indication of the determined sweet spot location in relation to the speaker location.

In another aspect, a method is provided for adjusting one or more received audio signals based on user input indicating a sweet spot location relative to a speaker. A sweet spot graphic is displayed at a display screen location in relation to a display screen location of a graphic representing a speaker location, based upon user input selecting the sweet spot graphic display screen location. A sweet spot location is determined in relation to the speaker location, based at least in part upon the speaker location and the user-selected sweet spot graphic display screen location in relation to the display screen location of the graphic representing the speaker location. An audio processor circuit is used to generate one or more adjusted audio signals based at least in part upon the one or more received audio signals, an indication of the determined sweet spot location in relation to the speaker location.

In another aspect, an example system is provided for adjusting one or more received audio signals based on a listener position relative to a speaker to provide a sweet spot at the listener position in a listening environment. A graphic display circuit causes display of a sweet spot graphic at a display screen location in relation to a display screen location of a graphic representing a speaker location, based upon user input selecting the sweet spot graphic display screen location. A sweet spot location positioning circuit to determine a sweet spot location in relation to the speaker location, based at least in part upon the speaker location and the user-selected sweet spot graphic display screen location in relation to the display screen location of the graphic representing the speaker location. A first sensor is configured to receive a first indication about one or more listener positions in a listening environment monitored by the first sensor. An audio processor circuit is configured to generate one or more adjusted audio signals based on (1) a selected one of the one or more listener positions corresponding to the determined sweet spot location in relation to the speaker location, (2) information about a position of the speaker relative to the first sensor, and (3) the one or more received audio signals.

In another aspect, a method is provided for adjusting one or more received audio signals based on a listener position relative to a speaker to provide a sweet spot at the listener position in a listening environment. A sweet spot graphic is displayed at a display screen location in relation to a display screen location of a graphic representing a speaker location, based upon user input selecting the sweet spot graphic display screen location. A sweet spot location is determined in relation to the speaker location, based at least in part upon the speaker location and the user-selected sweet spot graphic display screen location in relation to the display screen location of the graphic representing the speaker location. A first indication is received from a first sensor about one or more listener positions in a listening environment monitored by the first sensor. One or more adjusted audio signals are generated based on (1) a selected one of the received first indication about one or more listener positions from the first sensor selected based upon the determined sweet spot location in relation to the speaker location, (2) information about a position of the speaker relative to the first sensor, and (3) the one or more received audio signals.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B are illustrative drawings representing an example of a listener in a first sweet spot (FIG. 1A) in a physical 3D listening space and an example of the listener in outside the first sweet spot (FIG. 1B) in a physical 3D listening space.

FIG. 2A-2B are illustrative drawings representing an example graphical user interface (GUI) to provide feedback to a user manually adjusting position between a first location (FIG. 2A) and a second location (FIG. 2B), in accordance with some embodiments.

FIG. 2C is an illustrative drawing representing an example slider actuator to receive manual user input to adjustment of sweet spot distance from an audio source.

FIGS. 3A-3B are illustrative drawings representing an example of a listener in a first sweet spot (FIG. 3A) in a physical 3D listening space and an example of a listener in a second sweet spot (FIG. 3B) in the physical 3D listening space.

FIG. 4 is an illustrative block diagram of an audio system that includes an audio processor circuit and a GUI-based sweet spot location selection system.

FIG. 5 is an illustrative diagram illustrating operations of a method performed by an example sweet spot position determination circuit.

FIG. 6A illustrates generally an example of a block diagram of an audio system implementation including a first audio processor circuit implementation that includes a first virtualizer circuit and a first sweet spot adapter circuit.

FIG. 6B illustrates generally an example block diagram of an audio processing system including a second audio processor circuit implementation that includes a second virtualizer circuit and a second sweet spot adapter circuit.

FIG. 7 illustrates generally an example block diagram of an audio processing system including a third audio processor implementation that includes a third virtualizer circuit.

FIG. 8 is an illustrative block diagram of an audio system that includes a computer vision analysis circuit operatively coupled between the audio system and the GUI-based sweet spot location selection system.

FIG. 9 is an illustrative diagram illustrating operations of a method performed using an example image processor circuit to select a face image to track based upon input from a GUI-based sweet spot location selection system.

FIG. 10 is an illustrative drawing showing an image frame including multiple faces captured by a camera, a GUI image display indicating a user-selected listener location, and an image frame including a single on face image selected for tracking.

FIG. 11 is an illustrative example of binaural synthesis of a three-dimensional sound source using HRTFs.

FIG. 12 is an illustrative example of three-dimensional sound virtualization using a crosstalk canceller.

FIG. 13 illustrates generally an example of a method that includes estimating a listener position in a field of a view of a camera.

FIG. 14 illustrates generally an example of a listener face location relative to its projection on an image captured by a camera.

FIG. 15 illustrates generally an example of determining image coordinates.

FIG. 16 illustrates generally an example of determining coordinates of a listener in a field of view of a camera.

FIG. 17 illustrates generally an example of a relationship between a camera and a loudspeaker for a laptop computer.

FIG. 18 is a block diagram illustrating components of a machine, according to some examples, able to read instructions from a machine-readable medium and perform any one or more of the methodologies discussed herein.

### DETAILED DESCRIPTION

In the following description that includes examples of systems, methods, apparatuses, and devices for performing audio signal virtualization processing, such as for providing listener sweet spot adaptation in an environment based upon user input about a listener position provided through a graphical user interface (GUI), reference is made to the accompanying drawings, which form a part of the detailed description. The drawings show, by way of illustration, specific embodiments disclosed herein can be practiced. These embodiments are generally referred to herein as “examples.” Such examples can include elements in addition to those shown or described. However, the present embodiments also contemplate examples in which only those elements shown or described are provided. The present inventors contemplate examples using any combination or permutation of those elements shown or described (or one or more aspects thereof), either with respect to a particular example (or one or more aspects thereof), or with respect to other examples (or one or more aspects thereof) shown or described herein.

As used herein, the phrase “audio signal” is a signal that is representative of a physical sound. Audio processing systems and methods described herein can include hardware circuitry and/or software configured to use or process audio signals using various filters. In some examples, the systems and methods can use signals from, or signals corresponding to, multiple audio channels. In an example, an audio signal can include a digital signal that includes information corresponding to multiple audio channels.

Various audio processing systems and methods can be used to reproduce two-channel or multi-channel audio signals over various loudspeaker configurations. For example, audio signals can be reproduced over headphones, over a pair of bookshelf loudspeakers, or over a surround sound or immersive audio system, such as using loudspeakers positioned at various locations in an environment with respect to a listener. Some examples can include or use compelling spatial enhancement effects to enhance a listening experience, such as where a number or orientation of physical loudspeakers is limited.

In U.S. Pat. No. 8,000,485, to Walsh et al., entitled “Virtual Audio Processing for Loudspeaker or Headphone Playback”, which is hereby incorporated by reference in its entirety, audio signals can be processed with a virtualizer processor circuit to create virtualized signals and a modified stereo image. In U.S. Pat. No. 9,426,598, to Walsh et al., entitled, “Spatial Calibration of Surround Sound Systems Including Listener Position Estimation”, which is hereby incorporated by reference in its entirety, a microphone array is used to detect listener spatial position for spatial calibration. In commonly owned U.S. patent application Ser. No. 16/119,368, to Shi et al., filed Aug. 31, 2018, entitled, “Sweet Spot Adaptation for Virtualized Audio”, which is hereby incorporated by reference in its entirety, a camera is used to detect a listener's position and to adjust the sweet spot of an audio virtualizer to a user's actual listening position.

A 3D audio experience is generally limited to a small area or region in an environment that includes the two or more loudspeakers. The small area or region, referred to as the sweet spot, represents a location where the 3D audio experience is most pronounced and effective for providing a multi-dimensional listening experience for the listener. When the listener is away from the sweet spot, the listening experience degrades, which can lead to inaccurate localization of sound sources in the 3D space. Furthermore, unnatural signal coloration can occur or can be perceived by the listener outside of the sweet spot.

Using a microphone array or a camera may increase cost of an audio system such as a sound bar, for example. In addition, using a camera raises privacy concerns. Some people may not be comfortable with the idea of having a camera in the living room, for example. The present inventors have recognized that an audio processing system may be configured to allow a user to manually select a sweet spot. User location of a sweet spot should be performed with precision since a sweet spot occupies such a small area or region within a larger physical space and since 3D sound quality may drop off significantly outside the sweet spot. Example embodiments provide a graphical user interface (GUI) for a user to manually select an audio “sweet spot” at a physical location where 3D audio is to be most effectively received by a listener and for the audio system to translate the user instructions to a sweet spot location. In an example, the GUI provides a graphic representation of physical locations relative to an audio source such as one or more speakers within a physical 3D listening space. A user may indicate a physical sweet spot location within the physical 3D listening space based upon the graphic locations indicated by the GUI. The audio processing system may be configured to translate user selected locations represented graphically within the GUI to physical sweet spot locations within the physical 3D listening space.

Examples of the systems discussed herein may include or use an audio virtualizer circuit. In an example, relative virtualization filters, can be derived from head-related transfer functions, can be applied to render 3D audio information that is perceived by a listener as including sound information at various specified altitudes, or elevations, above or below a listener to further enhance a listener's experience. In an example, such virtual audio information is reproduced using a loudspeaker provided in a horizontal plane and the virtual audio information is perceived to originate from a loudspeaker or other source that is elevated relative to the horizontal plane, such as even when no physical or real loudspeaker exists in the perceived origination location. In an example, the virtual audio information provides an impression of sound elevation, or an auditory illusion, that extends from, and optionally includes, audio information in the horizontal plane. Similarly, virtualization filters can be applied to render virtual audio information perceived by a listener as including sound information at various locations within or among the horizontal plane, such as at locations that do not correspond to a physical location of a loudspeaker in the sound field. The audio virtualizer circuit can include a binaural synthesizer and a crosstalk canceller. In an example, the systems can further include a sweet-spot adapter circuit configured to enhance a listening experience for the listener based on the determined spatial position of the listener.

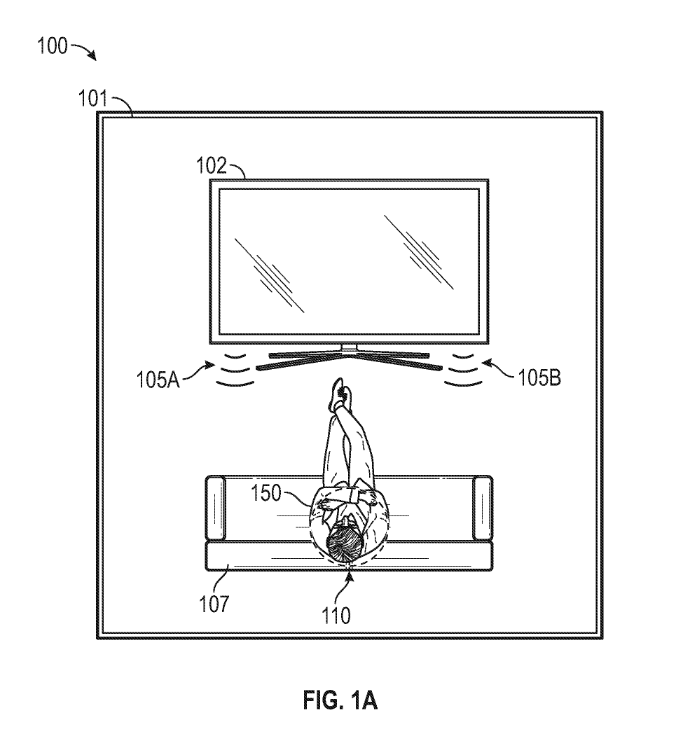

FIG. 1A is an illustrative drawing representing an example 100 of a listener 150 located at a first sweet spot 110 in a physical 3D listening space 101. In the example of FIG. 1A, the 3D listening space 101 includes a generally rectangular room. Although the listening space 101 is depicted in two dimensions, it is to be understood as including a three-dimensional environment that can be occupied by the listener 150 and one or more sound reproduction devices, among other things.

The example listening space 101 includes a television screen display 102. The television 102 includes an audio source including a pair of left and right speakers 105A and 105B. Although the pair of speakers 105A and 105B are illustrated as being integrated with the television 102, the pair of speakers 105A and 105B could be loudspeakers provided externally to the television 102, and optionally can be driven by a source other than a television. The pair of speakers 105A and 105B are oriented to project sound away from the face of the television 102 and toward an area, such as a couch (or sofa) 107, in the listening space 101 where the listener 150 is most likely to be positioned. Alternatively, for example, the pair of speakers 105A and 105B may be integrated with another entertainment media system or system component, a server computer, a client computer, a personal computer (PC), a tablet computer, a laptop computer, a netbook computer, or a mobile device such as a smart phone, for example.

The example of FIG. 1A illustrates generally an example of the first sweet spot 110, and the first sweet spot 110 represents a physical location in the 3D listening space 101 where 3D audio effects, such as included in sounds reproduced using the pair of speakers 105A and 105B, are perceived accurately by the listener 150. Although the first sweet spot 110 is illustrated in FIG. 1A as a two-dimensional area, the first sweet spot 110 can be understood to include a three-dimensional volume in the listening space 101. In the example of FIG. 1A, the listener 150 is located at the first sweet spot 110. That is, a head or ears of the listener 150 are located at or in the first sweet spot 110.

In an example, the pair of speakers 105A and 105B receives signals from an audio signal processor that includes or uses a virtualizer circuit to generate virtualized or 3D audio signals from one or more input signals. The audio signal processor can generate the virtualized audio signals using one or more HRTF filters, delay filters, frequency filters, or other audio filters.

FIG. 1B illustrates generally an example 150 of the listener 150 outside of the first sweet spot 110 in the 3D listening space 101. In the example 200, the listener 150 is positioned to the right side of the first sweet spot 110. Since the listener 150 is located outside of the first sweet spot 110, the listener 150 can experience or perceive less optimal audio source localization. In some examples, the listener 150 can experience unintended or disruptive coloration, phasing, or other sound artifacts that can be detrimental to the experience that listener 150 has with the audio program reproduced using the pair of speakers 105A and 105B. In an example, the systems and methods discussed herein can be used to process audio signals reproduced using an audio source that includes the pair of speakers 105A and 105B to move the first sweet spot 110 to a second location that coincides with a changed or actual position of the listener 150 in the listening environment 101.

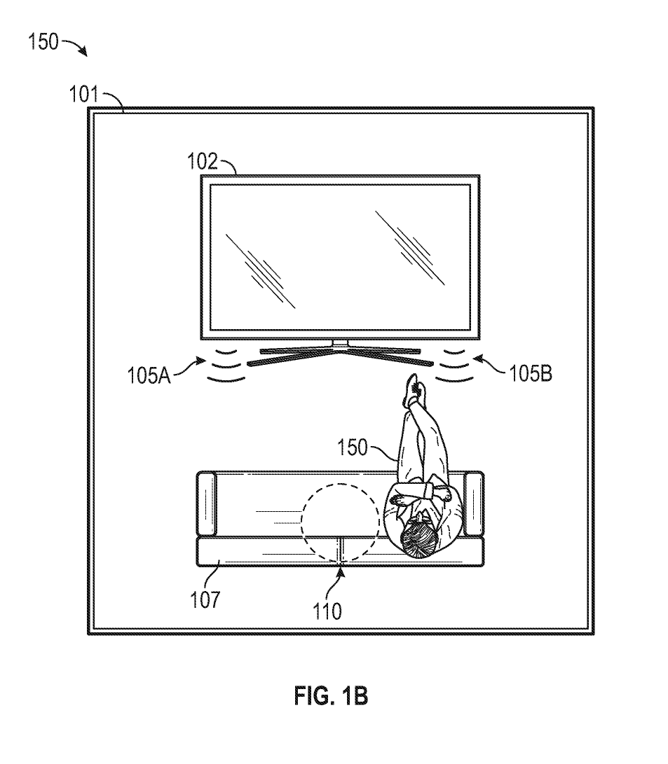

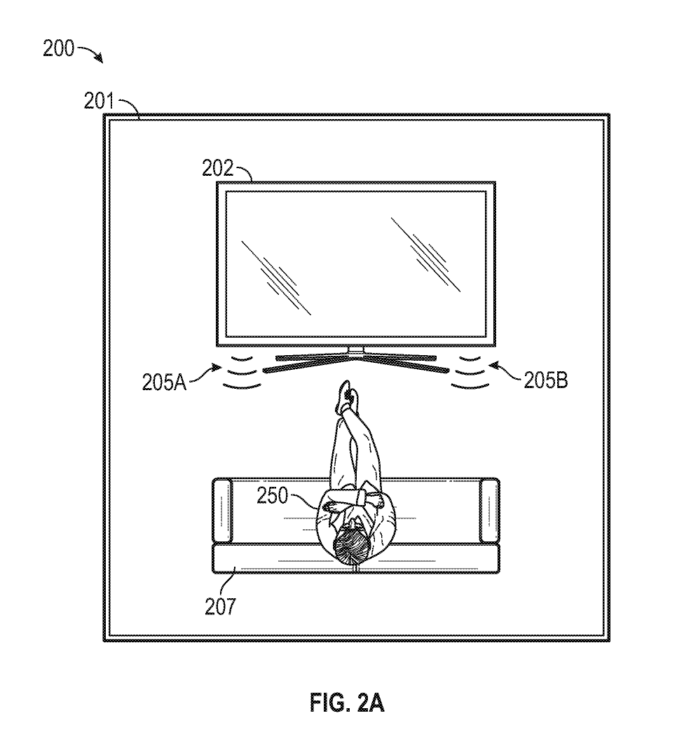

FIG. 2A-2B are illustrative drawings representing a display screen 200 displaying an example two-dimensional (2D) graphical user interface (GUI) 201 to generally represent the 3D physical 3D listening space of FIGS. 1A-1B. The GUI 201 provides feedback to a user who can manually select a physical sweet spot position within the example physical 3D space 101 as shown in FIGS. 3A-3B. The GUI 201 also may include an actuator such as a graphical slider bar 210 shown in FIG. 2C for a user to indicate distance of a selected sweet spot location from a speaker. In some examples, a user-indicated distance is a user's estimate of distance between a user's desired physical location of sweet spot and the first and second speakers 105A, 105B. In other words, a user-indicated distance is a user's estimate of distance between where a listener is to be positioned and the first and second speakers 105A, 105B. In some examples, since the speakers 105A, 105B are separated from one another, a user estimates a distance between a physical sweet spot location, where a listener is to be located, and a location in line with and centered between of the two speakers. The example GUI display 201 of FIGS. 2A-2B includes graphic speaker representation 205A, 205B and a graphic TV representation 202, a range of selectable listening locations 207 (e.g., a graphic showing a couch that is long enough to represent multiple listening positions), and a sweet spot positioner 250 (e.g., a moveable graphic representing a person who is the listener) to position a sweet spot within the range of selectable locations.

FIG. 3A is an illustrative drawing representing an example of a physical listener 150 in a first sweet spot position 110 (e.g., center of the physical couch 107) in the physical 3D listening space 101 corresponding to a user's positioning of the sweet spot positioner graphic 250 at a corresponding first sweet spot position (e.g., centered on the couch graphic 207) in the GUI 201 as shown in FIG. 2A. The first sweet spot position 110 in FIG. 3A is equidistant from the first and second speakers 105A, 105B and the corresponding sweet spot graphic 250 in FIG. 2A is equidistant from the first and second speaker graphics 205A, 205B. FIG. 3B is an illustrative drawing representing an example of a physical listener 150 in a second sweet spot position 110 (e.g., right side of the couch 107) in the physical 3D listening space 101 corresponding to a user's positioning of the sweet spot positioner 250 at a corresponding second sweet spot position (e.g., right side of the couch graphic 207) in the GUI 201 as shown in FIG. 2B. The first sweet spot position 110 in FIG. 3B is a less distant from speaker 105B than from speaker 105A, 105B, and the corresponding sweet spot graphic 250 in FIG. 2B is less distant from speaker graphic 105B than from speaker graphic 105B. The GUI 201 may be provided on a display screen of a mobile device such as a smart phone, a cellular telephone, a wearable device (e.g., a smart watch), or a personal digital assistant (PDA), for example. Alternatively, the GUI 201 may be displayed on a display screen of the television or other entertainment media system or system component, a server computer, a client computer, a personal computer (PC), a tablet computer, a laptop computer, a netbook computer, for example.

In the example GUI 201 of FIGS. 2A-2B, relative 2D positions of the graphic TV 202, graphic speakers 205A, 205B and the graphic listener location 250 on the graphic couch 207, correspond generally to relative physical positions of the physical TV 102, physical speakers 105A, 105B and the physical user 150 in the physical 3D space 101. FIGS. 3A-3B. A user selection of a position of the listener graphic 250 relative to the audio system graphic within the GUI 201 and an indication of a distance of a user-selected sweet spot from the speakers causes the audio system to generate a physical location of a sweet spot relative to the physical audio system within the physical 3D space 101 of FIGS. 3A-3B that corresponds to the user-selected position of the listener graphic within the GUI. It will be appreciated that although GUI 201 of FIGS. 2A-2B uses GUI graphic images that generally match the appearance of the physical objects in the 3D physical space FIGS. 3A-3B to indicate correspondence between graphic elements of the GUI and physical elements of the physical 3D space, in alternative examples, the GUI may instead provide more generalized graphic images. For instance, in some examples, the GUI may include furniture (not shown) graphics moveable within the 2D GUI scene to indicate different predetermined sweet spot locations where a graphic listener image may be located within the scene.

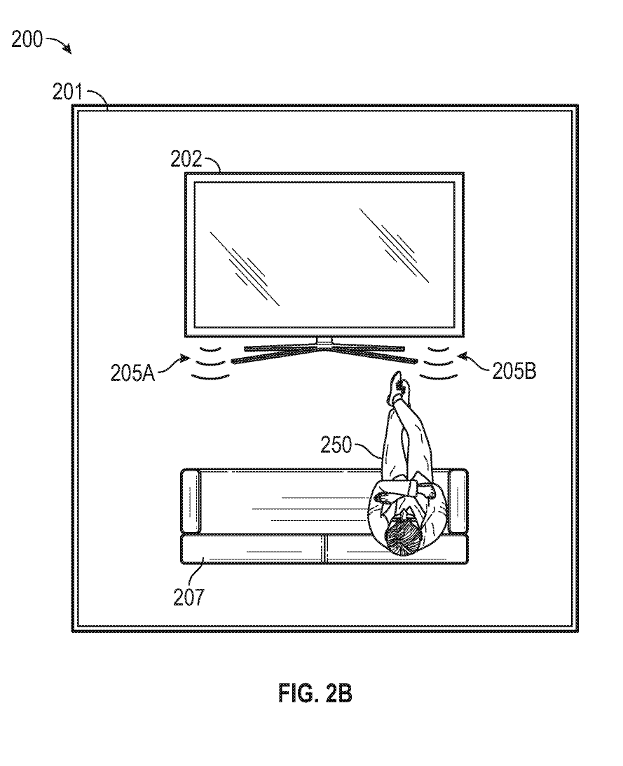

FIG. 4 is an illustrative block diagram of an audio system 400 that includes an audio processor circuit 410 and a GUI-based sweet spot location selection system 422. An audio source 401 such as TV, blu-ray, gaming console, laptop, for example, provides one or more audio input signals 403. The audio input signals 403 comprise one or more of a multi-channel audio file, audio stream, object-based audio program, or other signal or signals, such as can be suitable for listening using loudspeakers, headphones, or the like. The audio input signals 403 are provided to the first audio processor circuit 410, which processes the audio input signals, based upon sweet spot position location information provided by the GUI-based sweet spot selection location system 422, and produces resulting sweet spot adjusted audio output signals 407 that can be used to produce output audio 450 for provision to the speakers 105A, 105B. In one alternative example, the first audio processor circuit 410 imparts delay/gain adjustment to the output of the virtualizer. In another alternative example, the first audio processor circuit 410 feeds new coordinates to the virtualizer. In either case, the end result is a sweet spot adjusted audio signal output.

The GUI-based sweet spot selection system 422 includes a GUI display control circuit 426 to control a 2D display screen 200, a user input circuit 424, and a 3D sweet spot position determination circuit 428. The user input circuit 424 is configured to receive manual user input information 425 used to adjust an indication of a physical sweet spot location in relation to the speakers 105A, 105B. The GUI display control circuit 426 includes a sweet spot graphics module 427 configured to cause the display screen 200 to display a 2D GUI 201, such as that of FIGS. 2A-2B, in which 2D screen locations, e.g., pixels, correspond to physical locations in a 3D listening space. The GUI display control circuit 426 includes a distance graphics module 429 configured to cause the display screen 200 to display a user-selectable distance, such as that of FIG. 2C. Certain 2D graphic image locations within the GUI, such as a range of seating 2D locations upon the couch 207 in FIGS. 2A-2B, correspond to a corresponding range of physical locations within a physical 3D listening space, such as locations at the physical couch 107. The user input unit 424 receives manual user input information to select both a 2D GUI screen location and to select a corresponding physical location within a corresponding physical 3D listening space.

In operation, a user input 425 at the user input circuit 424 causes the GUI display control circuit 426 to cause the display screen 200 to display a graphical listener image 250 (e.g., an image of a person) at a user-selected 2D screen location. The example graphical couch image 207 of FIGS. 2A-2B represents a range of selectable 2D locations where the user can locate the graphical listener image 250. The displayed listener image 250 provides visual feedback to the user to indicate a location in the 2D GUI scene that corresponds to a 3D location in a physical listening space where a sweet spot is to be located. In other words, as explained below, the user's input causing positioning the graphical listener image 205 in the 2D GUI 201 also causes positioning of a listening sweet spot 110 in a physical 3D location 101. An example user input unit 424 includes a pointing device such as a mouse or up/down buttons, as explained above, to select a 2D location within the selectable range of 2D locations displayed within the GUI and also, to select a corresponding physical 3D location of a sweet spot.

Also, in operation, the user input 425 at the user input circuit 424 causes the sweet spot position determination circuit 428 to determine a sweet spot location within the physical 3D listening space. Referring to the GUI of FIGS. 2A-2B, different horizontally spaced apart 2D locations within the couch image 207 of the 2D GUI correspond to different 3D physical positions within the physical 3D listening space. For example, different 2D horizontal offsets from a center of the couch 207 in the GUI correspond to different azimuth angular offsets between the physical user and physical speakers 105A, 105B in a physical 3D listening space, and therefore, represent different physical distance offsets between the physical user and the speakers 105A, 105B, that is, the magnitude of the vector from the listener to each of the speakers. Referring to FIG. 2C, an interactive GUI slider bar 210 receives user input to indicate distance between a user and a plane that includes the two or more speakers. For a speaker system including a soundbar as in the GUI of FIGS. 2A-2C, the distance is assumed as the distance from a listener to a center of a physical soundbar in a listening space. For a speaker system including a set of stereo speakers the distance is the distance between the listener and the middle of a virtual line connecting the two speakers that typically corresponds to a phantom center image created by the stereo speakers assuming they are properly set-up.

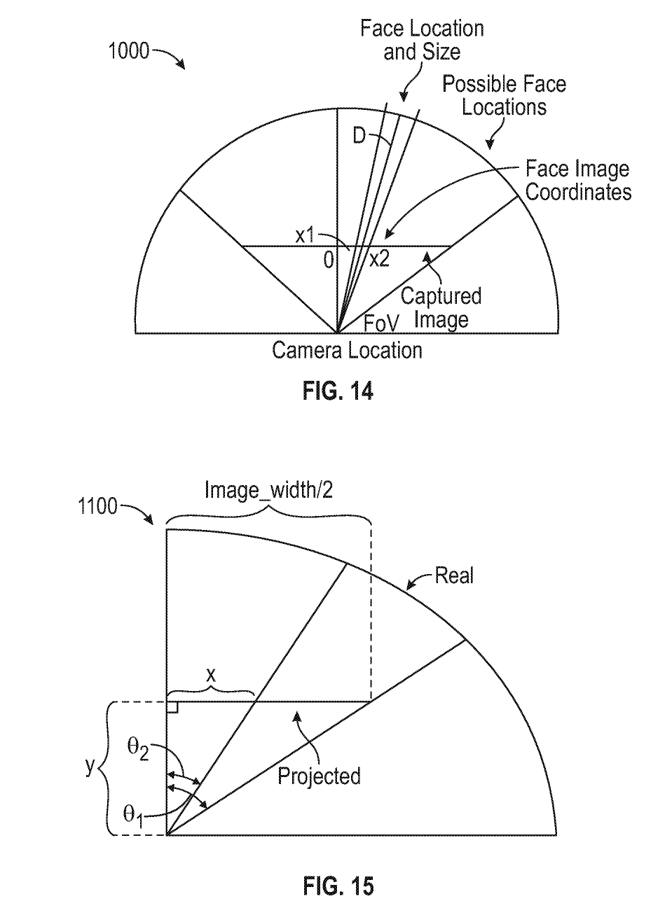

The sweet spot position determination circuit 428 determines sweet spot position based upon a user selected 2D GUI location within the couch 207 where a user positions a listener image 250 and a user-selected distance from a plane of the two or more speakers. More particularly, a user selected distance ‘d’ can now be used as the distance between the listener and the speakers in the equations for the cartesian coordinates, distance between the listener and the two loudspeakers, and delay and gain adjustment explained below with reference to FIG. 16. Alternatively, distance and azimuth/elevation can be fed to the virtualizer to process with corresponding HRTFs. Moreover, the sweet spot position determination circuit 428 provides a predetermined user head position (yaw, pitch, roll) in making 3D physical position determinations. Specifically, an example sweet spot position circuit 528 uses a forward-facing user head position as the predetermined head position.

In some examples, the user input circuit 424, the display unit 426, and the sweet spot position determination circuit 428 are integrated into a portable device such as a smart phone, a cellular telephone, a wearable device (e.g., a smart watch), or a personal digital assistant (PDA), for example. The display screen 200, user input unit 424 and the display control circuit 426 are integrated together in a touch screen, for example. One or more processor circuits of the portable device are configured to determine a sweet spot physical location based upon the user input to the user input unit 424 to control a listener graphic position in a GUI displayed by the display unit 426. In other examples, the display screen 200, user input unit 424, display control unit 424 and sweet spot position determination circuit 428 are integrated into an entertainment media system or system component, a personal computer (PC), a tablet computer screen, a laptop computer, or a netbook computer, which includes a mouse or keyboard that act as a user input circuit 424 and a separate display screen to act as a display unit 426 and one or more processors to determine a physical sweet spot based upon listener graphic position in a GUI, for example. In other examples, the user input unit 424 are wirelessly coupled to the display control circuit 426 and the sweet spot position determination circuit 428. For example, the user input circuit 424 and the display control circuit 426 are integrated into a television (TV) remote control device that can include physical actuators such as left, right, front, back buttons to receive user input commands, the display screen 200 includes the TV, and the sweet spot position determination circuit 428 includes one or more processors coupled to the TV and configured to determine a physical sweet spot based upon listener graphic position in a GUI.

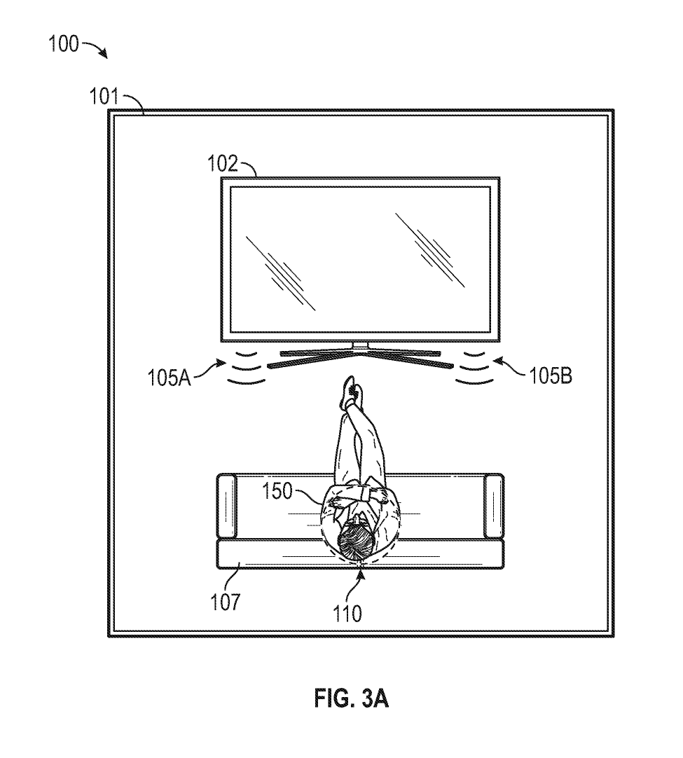

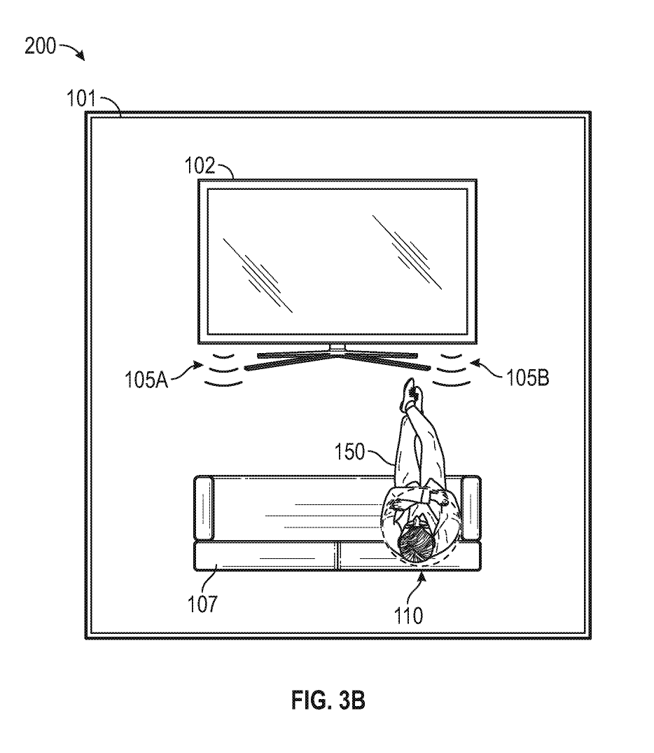

As explained more fully below with reference to FIGS. 6A-6B and FIG. 7, the audio processor circuit 410 is configured to generate virtualized audio signals at a physical 3D location for the pair of speakers 105A and 105B, based upon a user-selected 2D position of listener graphic 250 in the GUI display. The audio processor circuit 410 selects one or more filters to apply to the audio signals to produce virtualized audio signals for the pair of speakers 105A and 105B based on a user-selected position of a listener graphic 250 in a 2D GUI display to update or adjust a position of a physical 3D sweet spot in the physical listening environment 101.

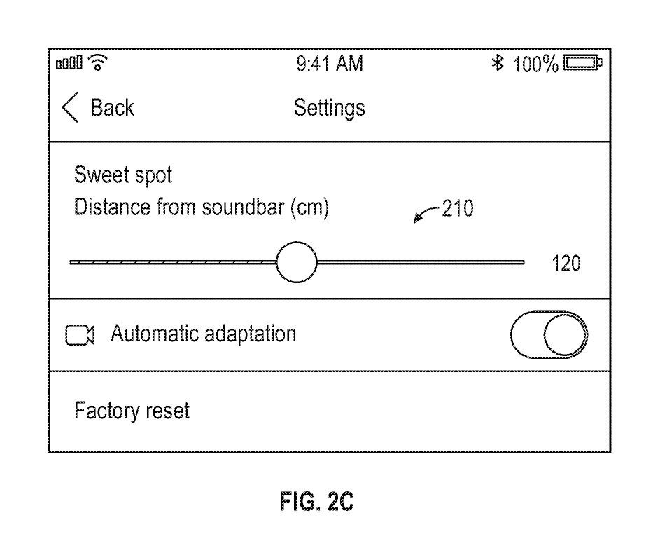

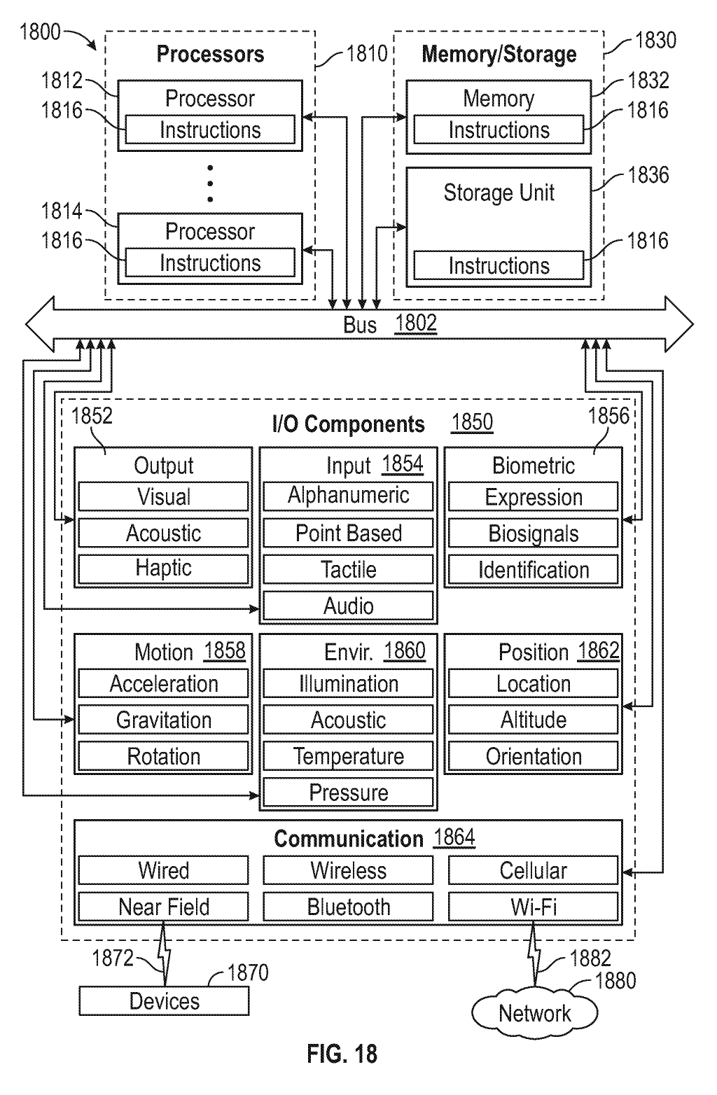

FIG. 5 is an illustrative diagram illustrating operations of a method 500 performed by an example sweet spot position determination circuit 428. Operations in the method 500 may be performed using machine components described below with respect to FIG. 18, using one or more processors (e.g., microprocessors or other hardware processors), or using any suitable combination thereof. A 2D location selection input operation 502 receives first user input 533 to indicate horizontal offset location. More particularly, the operation 502 receives user input to select a 2D screen location within the GUI display of FIGS. 2A-2B, selected from among the range of locations represented by the graphic couch image 207. A user distance selection input operation 504 receives second user input 535, such as input to the slider bar of FIG. 3, to select a user distance from a plane of the speakers 105A, 105B. An angle determination operation 506 determines an angle offset between a physical 3D location and two or more speakers 105A, 105B based upon the selected 2D screen location and the selected distance. An output operation 508 (indicated by dashed lines) provides the determined angle offset information, the received distance information and stored predetermined head position information (e.g., forward-facing yaw, pitch and roll) as output signals 531, to the audio processor 410.

FIGS. 6A-6B and FIG. 7 illustrate generally various block diagrams representing the audio system of FIG. 4 showing different implementations of the audio processor circuit 410 that can be used to perform virtualization processing based upon user input to the GUI-based sweet spot location selection system 422. FIG. 6A illustrates generally an example of a block diagram of an audio system implementation 400A including a first audio processor circuit implementation 410A that includes a first virtualizer circuit 512A and a first sweet spot adapter circuit 514A. In the example of FIG. 6A, the first virtualizer circuit 512A and the first sweet spot adapter circuit 514A comprise portions of the first audio processor circuit implementation 410A.

In operation, the first virtualizer circuit 512A in the first audio processor circuit implementation 510A is configured to apply virtualization processing to one or more of the audio input signals 503 to provide intermediate audio output signals 505A. In one example, the first virtualizer circuit 512A applies one or more virtualization filters based on a reference sweet spot or based on other information or considerations specific to the listening environment. In such example, the first virtualizer circuit 512A does not use the listener location signal 531 to influence its processing of the audio input signals 503. Instead, the first sweet spot adapter circuit 514A receives the listener location signal 531 and, based on the listener location signal 531 (e.g., a signal indicating or including information about a user-designated location of a listener 150 relative to one or more loudspeakers 105A, 105B in the listener's environment, applies gain and/or delay per the examples listed below. The virtualizer circuit 512A is responsible for applying virtualization filters to the signal.

The first sweet spot adapter circuit 514A then renders or provides audio the output signals 507A that can be reproduced using the audio output 450A. In an example, the first sweet spot adapter circuit 514A applies gain or attenuation to one or more of the intermediate audio output signals 505A to provide the audio output signals 507A. The gain or attenuation can be applied to specific frequencies or frequency bands. In an example, the first sweet spot adapter circuit 514A applies a delay to one or more of the intermediate audio output signals 505A to provide the audio output signals 507A.

In another example, the first virtualizer circuit 512A applies one or more virtualization filters based, at least in part, on the listener location signal 531 from the sweet spot positioner circuit 528. That is, one or more filters used by the first virtualizer circuit 512A to process the audio input signals 503 can be selected based on information about a user-selected listener position from the listener location signal 531. The first sweet spot adapter circuit 514A can also receive the listener location signal 531 and, based on the listener location signal 531 (e.g., a signal indicating or including information about a location of a listener relative to one or more loudspeakers in the listener's environment), select one or more filters for processing the intermediate audio output signals 505A received from the virtualizer circuit 512A.

FIG. 6B illustrates generally an example of the audio processing system of FIG. 4 including a block diagram of a second audio processor circuit implementation 510B that includes a second virtualizer circuit 512B and a second sweet spot adapter circuit 514B. In the example of FIG. 6B, the second virtualizer circuit 512B and the second sweet spot adapter circuit 514B comprise portions of a second audio processor circuit implementation 510B. The second audio processor circuit implementation 410B of FIG. 6B differs from the example of the first audio processor implementation 410A of FIG. 6A in that the second sweet spot adapter circuit 514B receives the audio input signals 503 from the audio source 401B, instead of the first virtualizer circuit 512A receiving the audio input signals 503. That is, the second sweet spot adapter circuit 514B can be configured to provide gain and/or delay or other filtering of the audio input signals 503, such as before audio virtualization processing is applied by the second virtualizer circuit 512B. The listener location signals 531 can be provided to the second sweet spot adapter circuit 514B, or to the second virtualizer circuit 512B, or to both the second sweet spot adapter circuit 514B and the second virtualizer circuit 512B. In the example of FIG. 6B, the second virtualizer circuit 512B renders or provides audio output signals 507B that can be reproduced using an audio output 450B.

FIG. 7 illustrates generally an example of the audio processing system 400 of FIG. 4 including a block diagram of a third audio processor implementation 410C that includes a third virtualizer circuit 612. In an example, the audio input signals 503 are received by the third virtualizer circuit 612 in the third audio processor circuit implementation 410C. The third virtualizer circuit 612 is configured to apply virtualization processing to one or more of the audio input signals 503 to provide audio output signals 607. In an example, the third virtualizer circuit 612 applies one or more virtualization filters based, at least in part, on the listener location signal 531 from the GUI-based sweet spot location selection system 422. That is, one or more filters used by the third virtualizer circuit 612 to process the audio input signals 503 can be selected based on information about the user-selected listener position from the listener location signals 531.

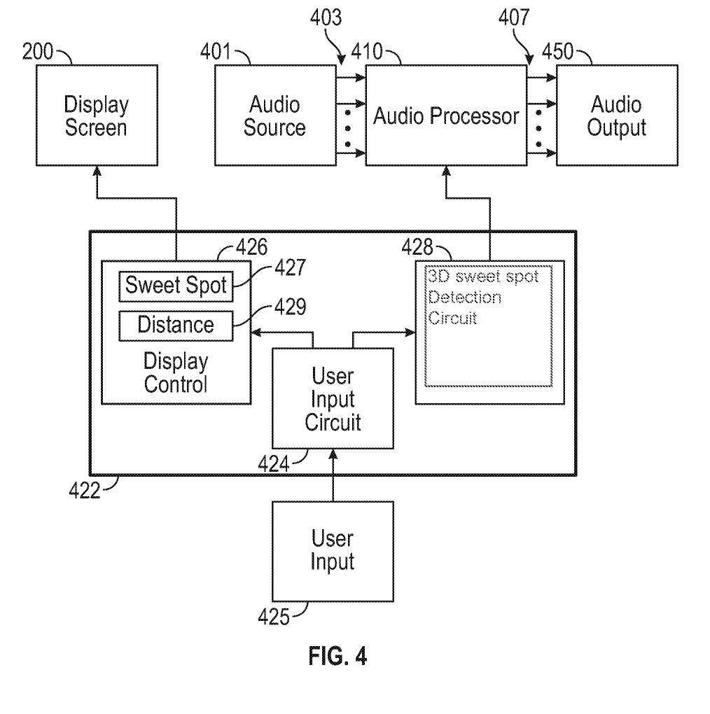

FIG. 8 is an illustrative block diagram of an audio system 800 that includes a computer vision analysis circuit 802 operatively coupled between the audio system 400 and the GUI-based sweet spot location selection system 422. The vision analysis circuit 802 can calculate a distance from a video image source 804 (e.g., from a depth sensor or camera) to a physical listener's face center (e.g., in millimeters) using an estimated face rectangle width (e.g., in pixels) or eye distance (e.g., in pixels). The distance calculation can be based on camera hardware parameters or experimental calibration parameters, among other things, for example using an assumption that a face width or distance between eyes is constant. The vision analysis circuit 802 provides visual tracking output signals 531D to an audio processor 410D configured to position a sweet spot based upon listener face location (e.g., distance and angle offset) and face orientation (e.g., yaw, pitch, roll). U.S. patent application Ser. No. 16/119,368, which is incorporated herein in its entirety, describes sweet spot positioning based upon face tracking, which will not be further described herein.

The GUI-based sweet spot location selection system 422 is operatively coupled to provide to the vision analysis circuit 802, the output signals 531 generated based upon first user input 533 that indicates a user-selected horizontal offset location and second user input 535 that indicates a user-selected distance as described with reference to FIG. 5. The vision analysis circuit 802 is configured to produce visual tracking output signals 531D indicative of a face image that appears within a captured video scene that corresponds to a user-selected location indicated by the output signals 531 provided by the GUI-based sweet spot location selection system 422. Thus, for example, a user may use the GUI-based sweet spot location selection system 422 to select a listener face image from among multiple listener face images that may appear in a visual scene, to be tracked by the vision analysis circuit 802.

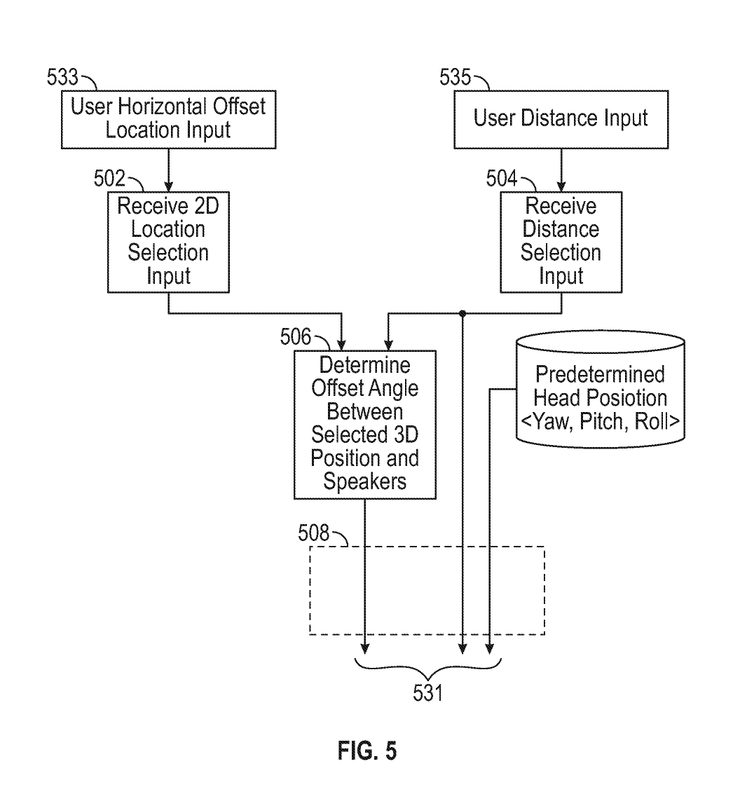

FIG. 9 is an illustrative diagram illustrating operations of a method 900 performed by an example image processor circuit 802 to select a face image to track based upon input from a GUI-based sweet spot location selection system 422. Operations in the method 900 may be performed using machine components described below with respect to FIG. 18, using one or more processors (e.g., microprocessors or other hardware processors), or using any suitable combination thereof. Operation 902 evaluates image information to identify each face image received from an image source 804 such as a camera. Decision operation 904 determines whether the image information includes more than one face image. In response to a determination at operation 904 that the image information includes more than one face image, operation 906 selects a face image based upon the output signals 531 provided by the GUI-based sweet spot location selection system 422. In response to a determination at operation 904 that the image information includes only one face image, operation 908 selects the sole face image. Operation 910 determines a sweet spot location in a physical 3D space based upon the selected face image according to the processes disclosed in the aforementioned U.S. patent application Ser. No. 16/119,368.

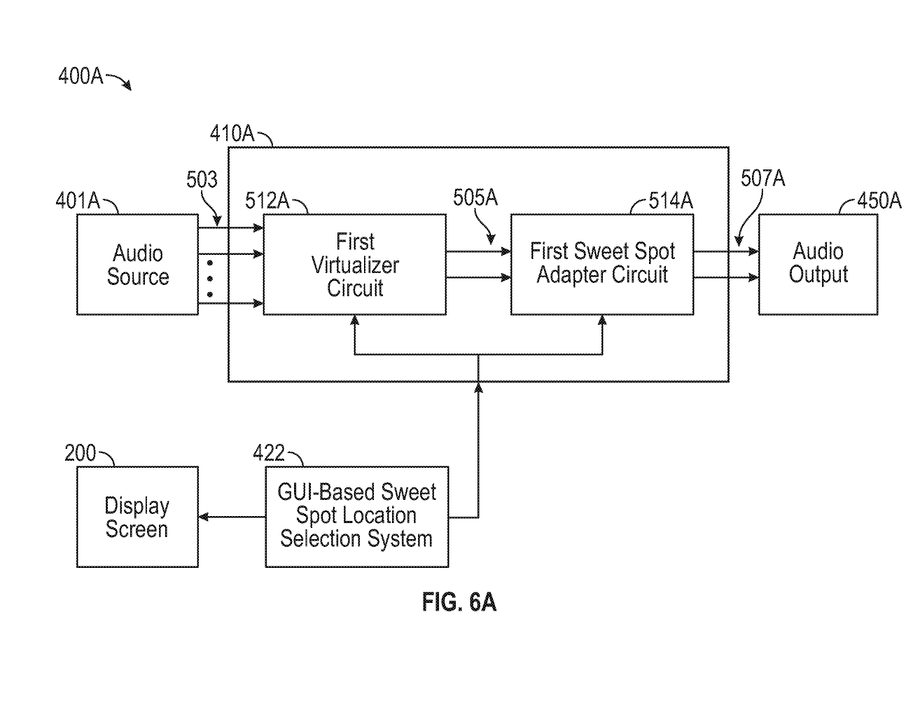

FIG. 10 is an example to illustrate the method of FIG. 9. FIG. 10 is an illustrative drawing showing an image frame 1002 including multiple faces A, B, C captured by a camera 804, a GUI image display 1004 indicating a user-selected listener location, and an image frame 1010 including a single face image C selected for tracking. The image information is evaluated at operation 902. In response to the decision operation 904 determining that the image frame 1002 includes multiple face images A, B, C, operation 906 uses selected listener location information 1004 produced by the GUI-based sweet spot location selection system to select a face image. In this illustrative example, operation 906 selects face image C. Operation 910 determines a sweet spot in a physical 3D listening space based upon the selected face image C.

In an example, implementation of 3D audio virtualization over loudspeakers includes or uses a binaural synthesizer and a crosstalk canceller. When an input signal is already binaurally rendered, such as for headphone listening, the binaural synthesizer step can be bypassed. Both the binaural synthesizer and the crosstalk canceller can use head related transfer functions (HRTFs). An HRTF is a frequency domain representation of HRIR (head related impulse response). HRTFs are transfer functions that result in acoustic transformations of a sound source propagating from a location in 3D space to the listener's ears, when applied to audio signals. Such a transformation can capture diffraction of sound due to, among other things, physical characteristics of the listener's head, torso, and pinna. HRTFs can generally be provided in pairs of filters, such as including one for a left ear, and one for a right ear.

In binaural synthesis, a sound source is convolved with a pair of HRIRs to synthesize the binaural signal received at the listener's ears. In the frequency domain, the binaural signal received at the listener's ears can be expressed as,

$$[ \begin{matrix}{B}_{L} \\ {B}_{R}\end{matrix} ] = [ \begin{matrix}{H}_{L} \\ {H}_{R}\end{matrix} ] S .$$

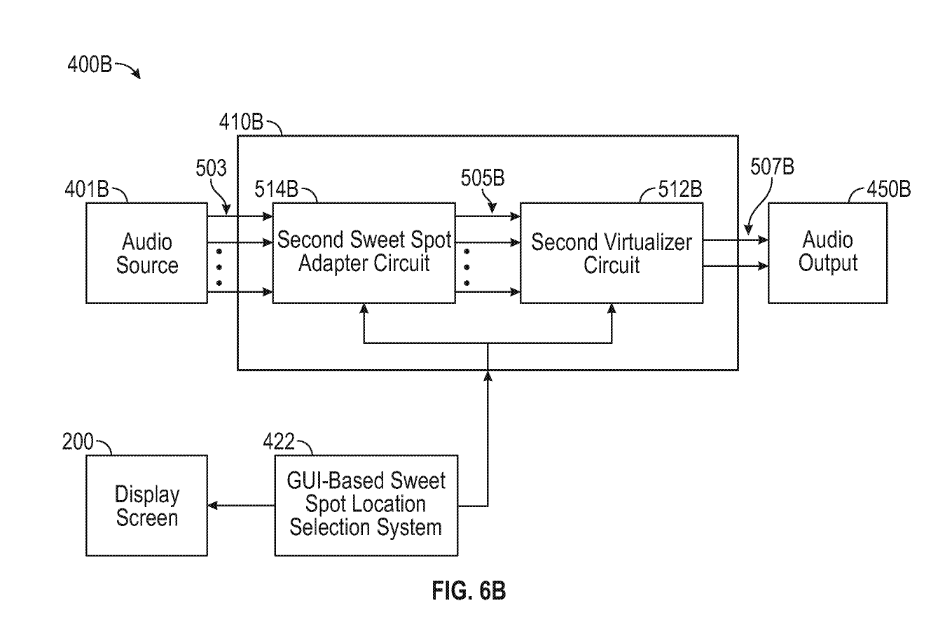

FIG. 11 illustrates generally an example of binaural synthesis of a three-dimensional sound source using HRTFs. In the example of FIG. 11, S denotes the sound source, H_{L} is an HRTF for the listener's left ear, H_{R} is an HRTF for the listener's right ear, B_{L} refers to a binaural signal received at the left ear, and B_{R} denotes a binaural signal received at the right ear. When there are multiple sound sources available at the same time, each sound source can be convolved with the associated pair of HRTFs. The resulting signals can be summed to synthesize the binaural signal received at the listener's ears. The resulting binaural signal can be suitable for headphone listening. In an example, various signal shaping or frequency response compensation can be applied to remove any undesirable transformation due to a headphone transducer.

In an example, to achieve 3D audio virtualization over two loudspeakers in a listening environment, an additional step is used to remove crosstalk from the left loudspeaker to the listener's right ear and from the right speaker to the listener's left ear.

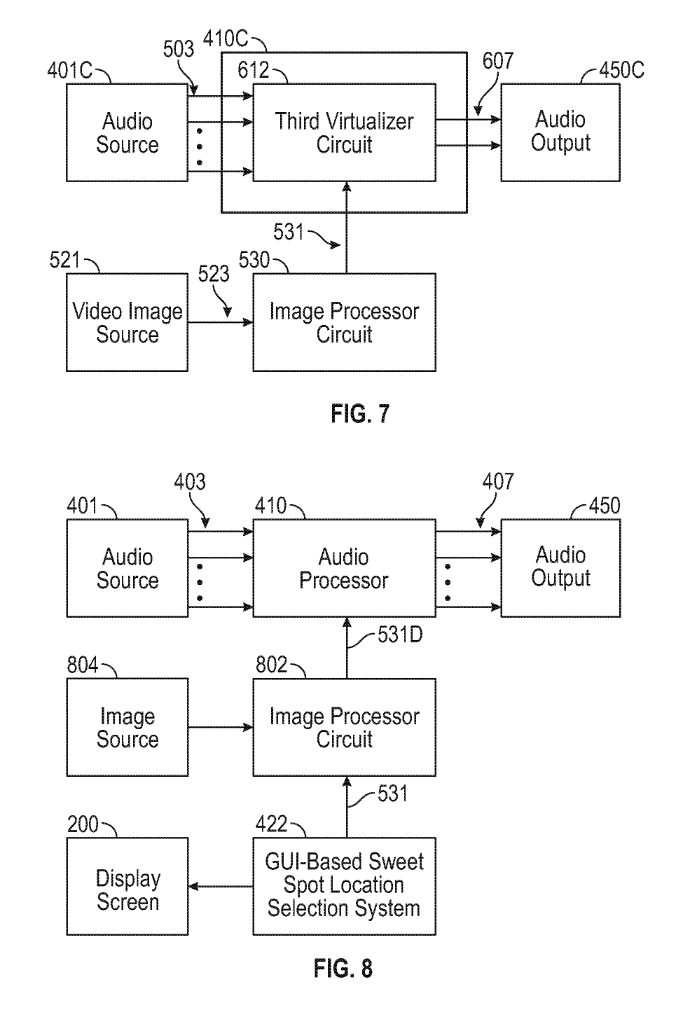

FIG. 12 illustrates generally an example of three-dimensional sound virtualization using a crosstalk canceler. In the example of FIG. 12, T_{LL} represents a transfer function from the left speaker to the left ear, T_{LR} denotes a transfer function from the left speaker to the right ear, T_{RL} represents a transfer function from the right speaker to the left ear, T_{RR} is a transfer function from the right speaker to the right ear, B_{L} is a left binaural signal, and B_{R} is a right binaural signal.

In the example of FIG. 12, a crosstalk canceller is applied to the output of the binaural synthesizer (B_{L} and B_{R}). The crosstalk canceller output signals are sent to the left and right side loudspeakers for playback. In an example, a crosstalk canceller C can be implemented as the inverse of the acoustic transfer matrix T such that the signals received at the listener's ears are exactly B_{L} and B_{R}. That is,

$$C = {T}^{- 1} = {[ \begin{matrix}{T}_{LL} & {T}_{RL} \\ {T}_{LR} & {T}_{RR}\end{matrix} ]}^{- 1} .$$

Crosstalk cancellation techniques often assume that loudspeakers are placed at symmetric locations with respect to the listener for simplicity. In spatial audio processing, such as using the systems and methods discussed herein, a location at which the listener perceives an optimal 3D audio effect is called the sweet spot (typically coincident with an axis of symmetry between the two loudspeakers). However, 3D audio effects will not be accurate if the listener is outside of the sweet spot, for example because the assumption of symmetry is violated.

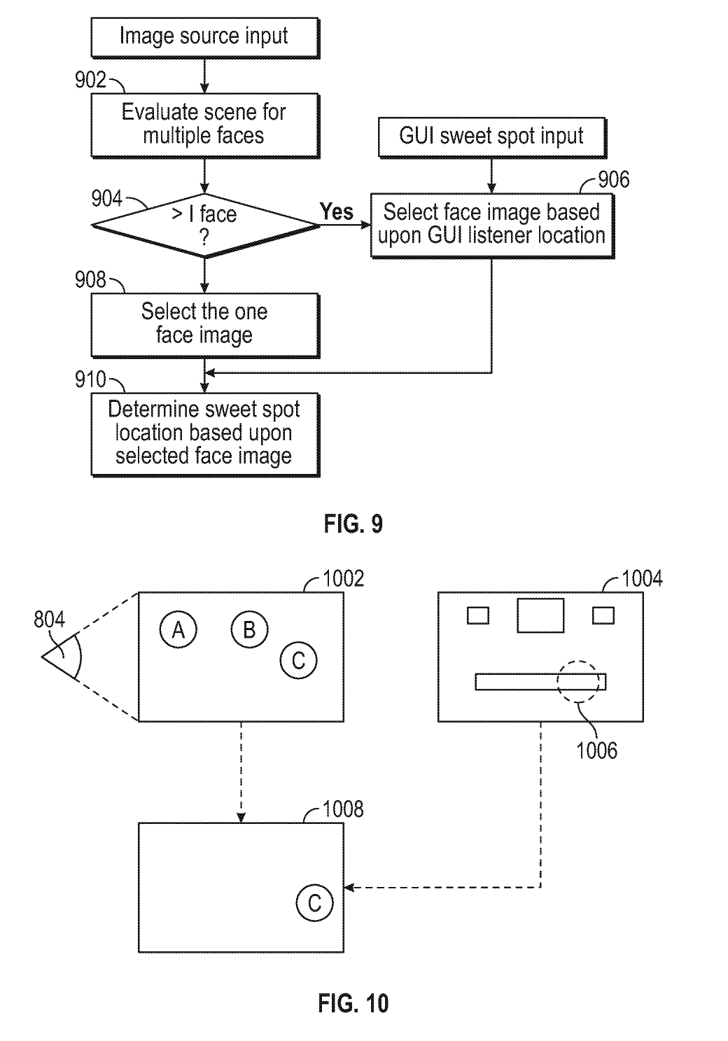

FIG. 13 illustrates generally an example of a method that includes estimating a listener position in a field of a view of a camera, such as the camera 301 and/or the video image source 521. In the example of FIG. 13, the method can include estimating the listener's distance first and then estimating the listener's azimuth angle and elevation angle based on the estimated distance. This method can be implemented as follows.

First, a machine or computer vision analysis circuit (e.g., the image processor circuit 530) can receive a video input stream (e.g., the image signal 523) from a camera (e.g., the camera 301 and/or the video image source 521) and, in response, provide or determine a face rectangle and/or information about a position of one or both eyes of a listener, such as using a first algorithm. The first algorithm can optionally use a distortion correction module before or after detecting the face rectangle, such as based on intrinsic parameters of the image source (e.g., of the camera or lens) to improve a precision of listener position estimation.

The machine or computer vision analysis circuit (e.g., the image processor circuit 530) can calculate a distance from the image source (e.g., from a depth sensor or camera) to the listener's face center (e.g., in millimeters) using the estimated face rectangle width (e.g., in pixels) or eye distance (e.g., in pixels). The distance calculation can be based on camera hardware parameters or experimental calibration parameters, among other things, for example using an assumption that a face width or distance between eyes is constant. In an example, an eye distance and/or head width can be assumed to have a fixed or reference value for most listeners, or for listeners most likely to be detected by the system. For example, most adult heads are about 14 cm in diameter, and most eyes are about 5 cm apart. These reference dimensions can be used to detect or correct information about a listener's orientation relative to the depth sensor or camera, for example, as a precursor to determining the listener's distance from the sensor. In other words, the system can be configured to first determine a listener's head orientation and then use the head orientation information to determine a distance from the sensor to the listener.

In an example, an eye distance, or interpupillary distance, can be assumed to be about 5 cm for a forward-facing listener. The interpupillary distance assumption can be adjusted based on, for example, an age or gender detection algorithm. The interpupillary distance corresponds to a certain width in pixels in a received image, such as can be converted to an angle using eye positions in the image, the camera's field of view, and formulas presented herein for the similar ‘face width’ algorithm. In this example, the angle value corresponds to a particular distance from the camera. Once a reference measurement is made (e.g., a reference distance to a listener in millimeters and corresponding interpupillary distance in pixels, such as converted to radians), a distance to the listener can be determined using a later-detected interpupillary distance, such as for the same or different forward-facing listener.

For a listener who may be facing a direction other than forward (e.g., at an angle relative to the camera), information from a head-orientation tracking algorithm (e.g., configured to detect or determine head yaw, roll and/or pitch angles) can be used to rotate a detected eye center position on a sphere of, for example, 143 millimeters diameter for an adult face. As similarly explained above for interpupillary distance, the assumed or reference head diameter can be changed according to, for example, the listener's age or gender. By rotating the detected eye center about the hypothetical sphere, corrected or corresponding forward-facing eye positions can be calculated.

Following the distance calculation, an optional classification algorithm can be used to enhance or improve accuracy of the position or distance estimation. For example, the classification algorithm can be configured to determine an age and/or gender of the listener and apply a corresponding face width parameter or eye distance parameter.

Next, with knowledge of the face image center in pixels (e.g., image_width/2, image_height/2) and the face center in pixels, the method can include calculating horizontal and vertical distances in the face plane in pixels. Assuming a constant adult face width (e.g., about 143 millimeters) and its detected size in pixels, the distances can be converted to millimeters, for example using:

distance (mm)=distance(pixels)*face_width (mm)/face_width(pixels).

Using the two distance values, the method can continue by calculating a diagonal distance from the image center to the face center. Now with a known distance from the camera to the listener's face and distance from the image center to the listener's face, the Pythagorean theorem can be used to calculate a distance to the face plane.

Next, an azimuth angle can be calculated. The azimuth angle is an angle between a center line of the face plane and a projection of the distance to the face in the horizontal plane. The azimuth angle can be calculated as the arctangent between the center line and the horizontal distance between the image center and the face position.

An elevation angle can similarly be determined. The elevation angle is an angle between a line from the camera to the face center and its projection to the horizontal plane across the image center. The elevation angle can be calculated as the arc sine of the ratio between the vertical distance and the listener distance.

Finally, an estimated listener position can be optionally filtered by applying hysteresis to reduce any undesirable fluctuations or abrupt changes in listener position.

In an example, another method for estimating a listener position in a listening environment includes determining the listener's distance and angle independently. This method uses information about the camera's field of view (FOV), such as can be obtained during a calibration activity.

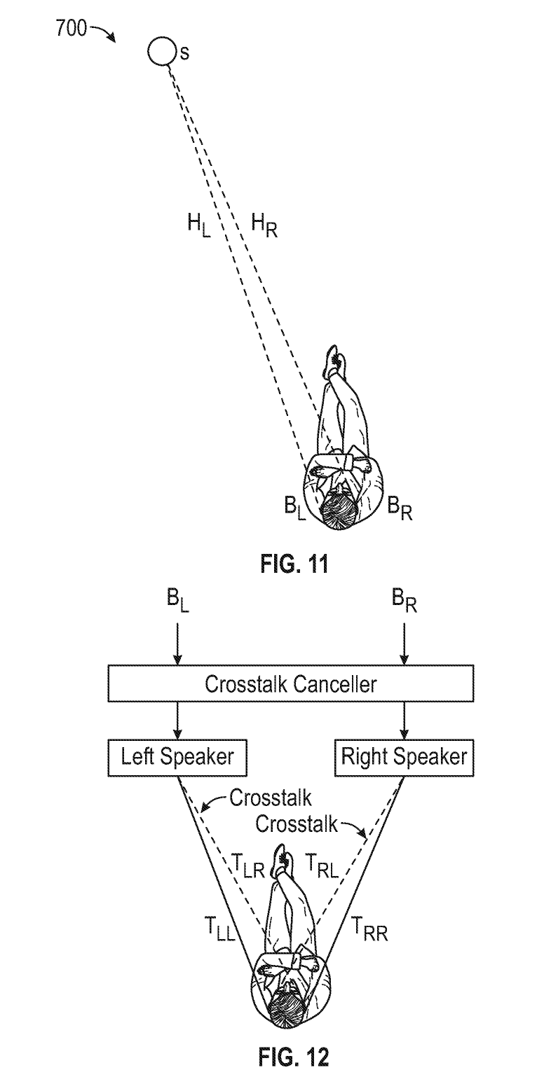

FIG. 14 illustrates generally an example 1000 of a listener face location relative to its projection on an image captured by a camera. A listener face moving in an environment, facing a camera and maintaining a relatively constant or unchanging distance relative to the camera, can approximately describe a sphere. Taking horizontal and vertical movements independently, the face can describe a circle on the horizontal axis and a circle on the vertical axis. Since the camera can only see in a certain or fixed field of view, only a portion of the circle may be visible to the camera. The visible portion is referred to generally as the field of view, or field of vision (FOV). The real scene is projected on the camera sensor through the camera's lens, for example following lines that pass through the image projection toward a center where the lines converge. With this insight, an angle, relative to the image center of each pixel in the image, can be recovered and expressed in radians, such as instead of pixels. In the example 1000, x1 and x2 represent locations of corners or edges of a listener's face, and D represents a distance to the camera.

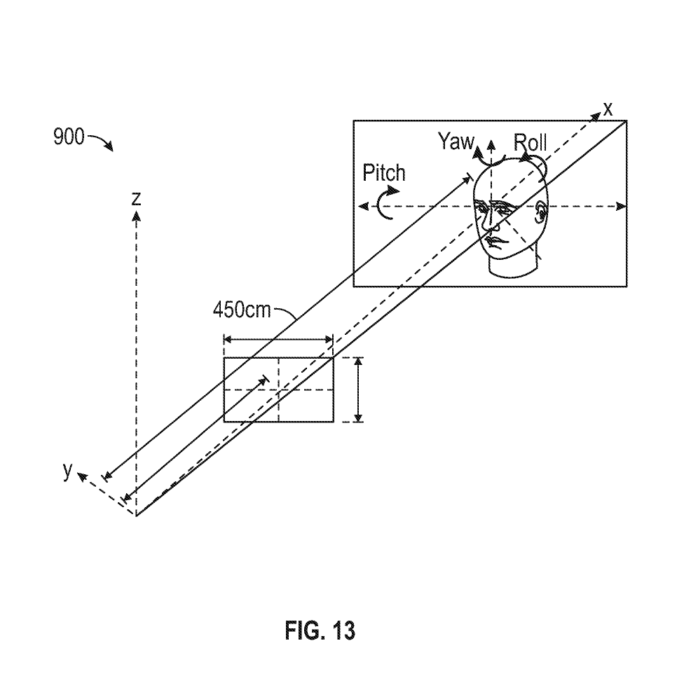

FIG. 15 illustrates generally an example 1100 of determining image coordinates. The example 1100 can include determining or recovering an angle for any image coordinate in the camera's field of view. In the example of FIG. 15, x indicates a position in an image that is to be estimated as an angle, and y indicates a calculated value from the image width and field of view that can be used to estimate any value x. The angle θ1 indicates half of the camera's field of view, and the angle θ2 indicates a desired angle value to determine, such as corresponding to x. The listener's azimuth angle (x_in_radians) can thus be calculated as,

$$y = \frac{\frac{image\_width}{2}}{tan ( \frac{Horizontal\_FOV}{2} * \frac{π}{180} )}$$

$$x\_in \_radians = {tan}^{- 1} ( \frac{x\_in \_pixels}{y} ) .$$

During a calibration event, a reference face distance to the camera (d_ref) can be measured and a corresponding reference face width in radians (w_ref) can be recorded. Using the reference values, for any face in the scene, a face width can be converted to radians (w_est) and the distance to camera d can be calculated as,

d=d_ref*w_ref/w_est.

In an example, if the horizontal FOV and the image size are known, then the vertical FOV can be calculated as,

$$Vertical\_FOV = \frac{Horizontal\_FOV}{Image\_Width} * Image\_Height .$$

The elevation angle in radians (e_in_radians) can be similarly calculated as,

$$y = \frac{\frac{image\_height}{2}}{tan ( \frac{Vertical\_FOV}{2} * \frac{π}{180} )}$$

$$e\_in \_radians = {tan}^{- 1} ( \frac{e\_in \_pixels}{y} ) .$$

Sweet spot adaptation, according to the systems and methods discussed herein, can be performed using one or a combination of virtualizer circuits and sweet spot adapter circuits, such as by applying delay and/or gain compensation to audio signals. In an example, a sweet spot adapter circuit applies delay and/or gain compensation to audio signals output from the virtualizer circuit, and the sweet spot adapter circuit applies a specified amount of delay and/or based on information about a listener position or orientation. In an example, a virtualizer circuit applies one or more different virtualization filters, such as HRTFs, and the one or more virtualization filters are selected based on information about a listener position or orientation. In an example, the virtualizer circuit and the sweet spot adapter circuit can be adjusted or configured to work together to realize appropriate audio virtualization for sweet spot adaptation or relocation in a listening environment.

Delay and gain compensation can be performed using a distance between the listener and two or more speakers used for playback of virtualized audio signals. The distance can be calculated using information about the listener's position relative to a camera and using information about a position of the loudspeakers relative to the camera. In an example, an image processor circuit can be configured to estimate or provide information about a listener's azimuth angle relative to the camera and/or to the loudspeaker, a distance from the listener to the camera, an elevation angle, and face yaw angle, face pitch angle, and/or roll angle relative to a reference plane or line.

FIG. 16 illustrates generally an example 1200 of determining coordinates of a listener in a field of view of a camera. For example, cartesian coordinates of a listener relative to a camera can be provided. In the example of FIG. 16, a position of the camera be the origin of the coordinate system. In this case, cartesian coordinates of the listener can be calculated using,

x=d cos(ϕ)cos(α)

y=d cos(ϕ)sin(α)

z=d sin(ϕ),
where d is an estimated distance between the camera and the listener, α is an azimuth angle, and ϕ is an elevation angle.

In an example, coordinates of the left speaker and right speaker can be [xₗ yₗ z₁] and [xᵣ yᵣ zᵣ] respectively. A distance between the listener and the two loudspeakers can then be calculated as,

dₗ=\sqrt{(x−xₗ)²+(y−yₗ)²+(z−zₗ)²}

dᵣ=\sqrt{(x−xᵣ)²+(y−yᵣ)²+(z−zᵣ)²}.

A delay in samples (D) can be calculated as

$$D = ( {d}_{l} - {d}_{r} ) * \frac{sampling rate}{C} ,$$

such as where C is the speed of sound in air (approximately 343 m/s at room temperature). If D is positive, then a delay is applied to the right channel. Otherwise, the delay is applied to the left channel.

In an example, gain compensation can be applied to one or more audio signals or channels, such as additionally or alternatively to delay. In an example, gain compensation can be based on a distance difference between the two loudspeakers. For example, a gain in dB can be calculated as,

gain=20*log₁₀(dₗ/dᵣ).

To preserve an overall sound level, a gain of a more distant speaker relative to the listener can increased while the gain of a nearer speaker can be decreased. In such case, an applied gain can be about half of the calculated gain value.

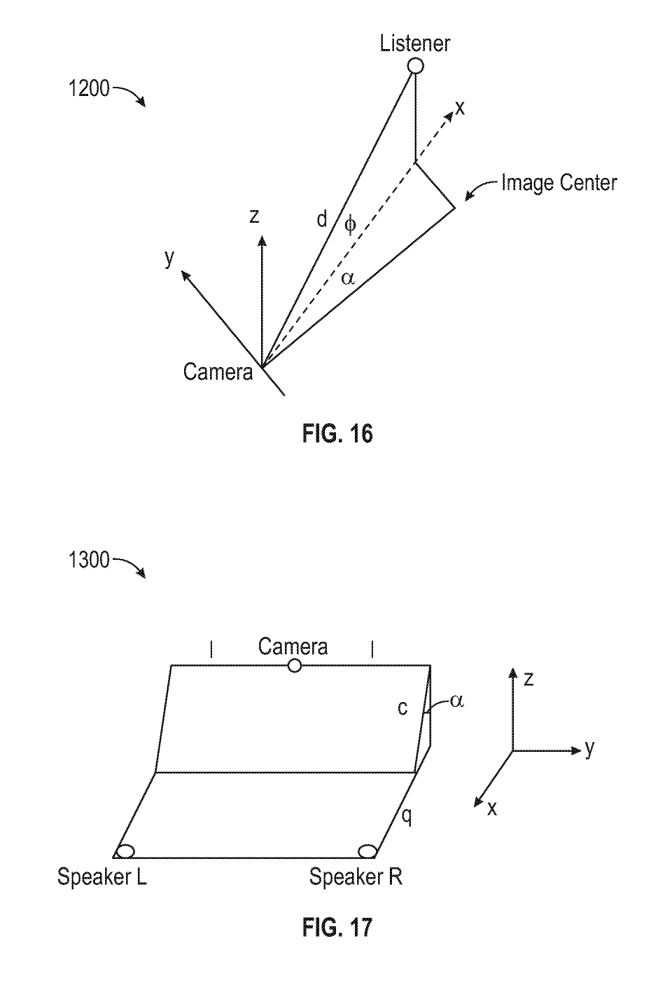

FIG. 17 illustrates generally an example 1300 of a relationship between a camera and a loudspeaker for a laptop computer. In the example of FIG. 17, left and right loudspeakers (Speaker L and Speaker R) fixed to the laptop computer can have a different axis than a camera fixed to the same laptop computer. Additionally, a screen angle of the laptop computer is typically not exactly 90 degrees. Referring to FIG. 17, if a position of the camera is considered the origin of a coordinate system, then the position of the left speaker, Speaker L, can be expressed as,

x=c sin(α)+q

y=−l

=−c cos(α).

Similarly, a position of the right speaker, Speaker R, can be expressed as

x=c sin(α)+q

y=l

=−c cos(α).

In an example, when q is 0 and c is 0, then positions of the left and right speakers are [x=0, y=−l, z=0] and [x=0, y=l, z=0], respectively. In this case, the two speakers are coincident with the y axis. Such an orientation can be typical in, for example, implementations that include or use a sound bar (see, e.g., the example of FIG. 4).

In an example, when q is 0 and α is 0, then positions of the left and right speakers are [x=0, y=−l, z=−c] and [x=0, y=l, z=−c], respectively. In this case, the two speakers are on the y-z plane. Such an orientation can be typical in, for example, implementations that include a TV (see, e.g., the examples of FIGS. 1-3).

Due to a variable screen angle of a laptop computer, however, a pitch angle of the camera may not be identically 0. That is, the camera may not face, or be coincident with, the x-axis direction. Thus, a detected listener position can be adjusted before computing a distance between the listener and the two speakers. The listener's position can be rotated by the camera pitch angle in the x-z plane so that the camera faces the x-axis direction. For example, the adjusted listener position can be expressed as

x′=cos(α)x−sin(α)z

y′=y.

z′=sin(α)x+cos(α)z

After the listener position is adjusted, a distance from the listener to each speaker can be calculated.

As discussed earlier, it can be beneficial to a user experience to filter delay and gain parameters to accommodate various changes or fluctuations in a determined listener position. That is, it can be beneficial to the listener experience to filter an estimated delay value (Dest) and/or an estimated gain value (Gest) to reduce unintended audio fluctuations. An efficient approach is to apply a running average filter, for example,

Dₙₑₓₜ=(1−α)Dₚᵣₑᵥ+αDₑₛₜ,

Gₙₑₓₜ=(1−α)Gₚᵣₑᵥ+αGₑₛₜ,

Where α is a smoothing constant between 0 and 1, Dₙₑₓₜ and Gₙₑₓₜ are subsequent or next delay and gain values, and Dₚᵣₑᵥ and Gₚᵣₑᵥ are previous delay and gain values. Alternative approaches for smoothing such as median filtering can additionally or alternatively be used.

Alternate embodiments of the 3D sweet spot adaptation systems and methods discussed herein are possible. Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines, circuits, and computing systems that can function together. For example, audio virtualization and sweet spot adaptation can be performed using discrete circuits or systems, or can be performed using a common, general purpose processor.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document. Embodiments of the sweet spot adaptation and image processing methods and techniques described herein are operational within numerous types of general purpose or special purpose computing system environments or configurations, such as described in the discussion of FIG. 18.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Further, one or any combination of software, programs, or computer program products that embody some or all of the various examples of the virtualization and/or sweet spot adaptation described herein, or portions thereof, may be stored, received, transmitted, or read from any desired combination of computer or machine readable media or storage devices and communication media in the form of computer executable instructions or other data structures. Although the present subject matter is described in language specific to structural features and methodological acts, it is to be understood that the subject matter defined in the appended claims is not necessarily limited to the specific features or acts described herein. Rather, the specific features and acts described above are disclosed as example forms of implementing the claims.

Various systems and machines can be configured to perform or carry out one or more of the signal processing tasks described herein, including but not limited to listener position or orientation determination or estimation using information from a sensor or image, audio virtualization processing such as using HRTFs, and/or audio signal processing for sweet spot adaptation such as using gain and/or delay filtering of one or more signals. Any one or more of the disclosed circuits or processing tasks can be implemented or performed using a general-purpose machine or using a special, purpose-built machine that performs the various processing tasks, such as using instructions retrieved from a tangible, non-transitory, processor-readable medium. FIG. 18 is a block diagram illustrating components of a machine 1800, according to some examples, able to read instructions 1816 from a machine-readable medium (e.g., a machine-readable storage medium) and perform any one or more of the methodologies discussed herein. Specifically, FIG. 18 shows a diagrammatic representation of the machine 1800 in the example form of a computer system, within which the instructions 1816 (e.g., software, a program, an application, an applet, an app, or other executable code) for causing the machine 1800 to perform any one or more of the methodologies discussed herein may be executed. For example, the instructions 1816 can implement one or more of the modules or circuits or components of FIGS. 4, 5, 6A-6B, 7, and/or 8, such as can be configured to carry out the audio signal processing and/or image signal processing discussed herein. The instructions 1816 can transform the general, non-programmed machine 1800 into a particular machine programmed to carry out the described and illustrated functions in the manner described (e.g., as an audio processor circuit). In alternative embodiments, the machine 1800 operates as a standalone device or can be coupled (e.g., networked) to other machines. In a networked deployment, the machine 1800 can operate in the capacity of a server machine or a client machine in a server-client network environment, or as a peer machine in a peer-to-peer (or distributed) network environment.

The machine 1800 can comprise, but is not limited to, a server computer, a client computer, a personal computer (PC), a tablet computer, a laptop computer, a netbook, a set-top box (STB), a personal digital assistant (PDA), an entertainment media system or system component, a cellular telephone, a smart phone, a mobile device, a wearable device (e.g., a smart watch), a smart home device (e.g., a smart appliance), other smart devices, a web appliance, a network router, a network switch, a network bridge, a headphone driver, or any machine capable of executing the instructions 1816, sequentially or otherwise, that specify actions to be taken by the machine 1800. Further, while only a single machine 1800 is illustrated, the term “machine” shall also be taken to include a collection of machines 1800 that individually or jointly execute the instructions 181618161816 to perform any one or more of the methodologies discussed herein.

The machine 1800 can include or use processors 1410, such as including an audio processor circuit, non-transitory memory/storage 1830, and UO components 1850, which can be configured to communicate with each other such as via a bus 18021802. In an example embodiment, the processors 1410 (e.g., a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) can include, for example, a circuit such as a processor 1812 and a processor 1414 that may execute the instructions 1816. The term “processor” is intended to include a multi-core processor 1812, 1414 that can comprise two or more independent processors 1812, 1414 (sometimes referred to as “cores”) that may execute the instructions 1816 contemporaneously. Although FIG. 18 shows multiple processors 1410, the machine 1800 may include a single processor 1812, 1414 with a single core, a single processor 1812, 1414 with multiple cores (e.g., a multi-core processor 1812, 1414), multiple processors 1812, 1414 with a single core, multiple processors 1812, 1414 with multiples cores, or any combination thereof, wherein any one or more of the processors can include a circuit configured to encode audio and/or video signal information, or other data.

The memory/storage 1830 can include a memory 1832, such as a main memory circuit, or other memory storage circuit, and a storage unit 1836, both accessible to the processors 1410 such as via the bus 18021802. The storage unit 1836 and memory 1832 store the instructions 1816 embodying any one or more of the methodologies or functions described herein. The instructions 1816 may also reside, completely or partially, within the memory 1832, within the storage unit 1836, within at least one of the processors 1410 (e.g., within the cache memory of processor 1812, 1414), or any suitable combination thereof, during execution thereof by the machine 1800. Accordingly, the memory 1832, the storage unit 1836, and the memory of the processors 1410 are examples of machine-readable media. In an example, the memory/storage 1830 comprises the look-ahead buffer circuit 120 or one or more instances thereof.

As used herein, “machine-readable medium” means a device able to store the instructions 1816 and data temporarily or permanently and may include, but not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 1816. The term “machine-readable medium” shall also be taken to include any medium, or combination of multiple media, that is capable of storing instructions (e.g., instructions 1816) for execution by a machine (e.g., machine 1800), such that the instructions 1816, when executed by one or more processors of the machine 1800 (e.g., processors 1410), cause the machine 1800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1850 may include a variety of components to receive input, provide output, produce output, transmit information, exchange information, capture measurements, and so on. The specific I/O components 1850 that are included in a particular machine 1800 will depend on the type of machine 1800. For example, portable machines such as mobile phones will likely include a touch input device, camera, or other such input mechanisms, while a headless server machine will likely not include such a touch input device. It will be appreciated that the I/O components 1850 may include many other components that are not shown in FIG. 18. The I/O components 1850 are grouped by functionality merely for simplifying the following discussion, and the grouping is in no way limiting. In various example embodiments, the I/O components 1850 may include output components 1852 and input components 1854. The output components 1852 can include visual components (e.g., a display such as a plasma display panel (PDP), a light emitting diode (LED) display, a liquid crystal display (LCD), a projector, or a cathode ray tube (CRT)), acoustic components (e.g., loudspeakers), haptic components (e.g., a vibratory motor, resistance mechanisms), other signal generators, and so forth. The input components 1854 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), video input components, and the like.

In further example embodiments, the I/O components 1850 can include biometric components 1856, motion components 1858, environmental components 1860, or position (e.g., position and/or orientation) components 1462, among a wide array of other components. For example, the biometric components 1856 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like, such as can influence inclusion, use, or selection of a listener-specific or environment-specific filter. The motion components 1858 can include acceleration sensor components (e.g., accelerometer), gravitation sensor components, rotation sensor components (e.g., gyroscope), and so forth, such as can be used to track changes in a location of a listener, such as can be further considered or used by the processor to update or adjust a sweet spot. The environmental components 1860 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect reverberation decay times, such as for one or more frequencies or frequency bands), proximity sensor or room volume sensing components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1462 can include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1850 can include communication components 1860 operable to couple the machine 1800 to a network 1880 or devices 1870 via a coupling 1882 and a coupling 1872 respectively. For example, the communication components 1860 can include a network interface component or other suitable device to interface with the network 1880. In further examples, the communication components 1860 can include wired communication components, wireless communication components, cellular communication components, near field communication (NFC) components, Bluetooth® components (e.g., Bluetooth® Low Energy), Wi-Fi® components, and other communication components to provide communication via other modalities. The devices 1870 can be another machine or any of a wide variety of peripheral devices (e.g., a peripheral device coupled via a USB).

Moreover, the communication components 1860 can detect identifiers or include components operable to detect identifiers. For example, the communication components 1860 can include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF49, Ultra Code, UCC RSS-2D bar code, and other optical codes), or acoustic detection components (e.g., microphones to identify tagged audio signals). In addition, a variety of information can be derived via the communication components 1860, such as location via Internet Protocol (IP) geolocation, location via Wi-Fi® signal triangulation, location via detecting an NFC beacon signal that may indicate a particular location, and so forth. Such identifiers can be used to determine information about one or more of a reference or local impulse response, reference or local environment characteristic, or a listener-specific characteristic.

In various example embodiments, one or more portions of the network 1880, such as can be used to transmit encoded frame data or frame data to be encoded, can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1880 or a portion of the network 1880 can include a wireless or cellular network and the coupling 1882 may be a Code Division Multiple Access (CDMA) connection, a Global System for Mobile communications (GSM) connection, or another type of cellular or wireless coupling. In this example, the coupling 1882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

While the above detailed description has shown, described, and pointed out novel features as applied to various embodiments, it will be understood that various omissions, substitutions, and changes in the form and details of the devices or algorithms illustrated can be made. As will be recognized, certain embodiments of the inventions described herein can be embodied within a form that does not provide all of the features and benefits set forth herein, as some features can be used or practiced separately from others.

Moreover, although the subject matter has been described in language specific to structural features or methods or acts, it is to be understood that the subject matter defined in the appended claims is not necessarily limited to the specific features or acts described above. Rather, the specific features and acts described above are disclosed as example forms of implementing the claims. The instructions 1816 can be transmitted or received over the network 1880 using a transmission medium via a network interface device (e.g., a network interface component included in the communication components 1860) and using any one of a number of well-known transfer protocols (e.g., hypertext transfer protocol (HTTP)). Similarly, the instructions 1816 can be transmitted or received using a transmission medium via the coupling 1872 (e.g., a peer-to-peer coupling) to the devices 1870. The term “transmission medium” shall be taken to include any intangible medium that is capable of storing, encoding, or carrying the instructions 1816 for execution by the machine 1800, and includes digital or analog communications signals or other intangible media to facilitate communication of such software.

1. A system for adjusting one or more received audio signals based on user input indicating a sweet spot location relative to a speaker, the system comprising:
a graphic display circuit to cause display of a sweet spot graphic at a display screen location in relation to a display screen location of a graphic representing a speaker location, based upon user input selecting the sweet spot graphic display screen location;
a 3D sweet spot position determination circuit to determine a sweet spot location in relation to the speaker location, based at least in part upon the speaker location and the user-selected sweet spot graphic display screen location in relation to the display screen location of the graphic representing the speaker location; and
an audio processor circuit configured to generate one or more adjusted audio signals based at least in part upon the one or more received audio signals and an indication of the determined sweet spot location in relation to the speaker location.

2. The system of claim 1
wherein the graphic display circuit further to cause display at the display screen of a distance graphic indicating a user selected distance; and
wherein the 3D sweet spot position determination circuit to determine the sweet spot location in relation to the speaker location, based at least in part upon both the physical speaker location and the user-selected sweet spot graphic display screen location in relation to the display screen location of the graphic representing a speaker location.

3. The system of claim 1,
wherein the graphic display circuit further to cause display at the display screen of a graphic representing a range of user selectable sweet spot graphic locations in relation to the display screen location of the graphic representing the speaker location.

4. The system of claim 1,
wherein the graphic display circuit further to cause display at the display screen of a graphic representing a range of user selectable sweet spot graphic locations at different distances on the display screen from the display screen location of the graphic representing the speaker location.

5. The system of claim 1,
wherein the audio processor circuit is configured to use one or more of predetermined head yaw, head pitch, or head roll parameters to generate the one or more adjusted audio signals.

6. The system of claim 1,
wherein the audio processor circuit includes a virtualizer circuit and a sweet spot adapter circuit;
wherein the virtualizer circuit is configured to receive the one or more received audio signals and generate virtualized audio signals based on a first virtualization filter; and
wherein the sweet spot adapter circuit is configured to receive the virtualized audio signals from the virtualizer circuit and provide the one or more adjusted audio signals based at least in part upon the indication of the determined sweet spot location in relation to the speaker location.

7. The system of claim 6,
wherein the sweet spot adapter circuit is configured to apply a gain and/or a delay to at least one audio signal channel of the received virtualized audio signals, wherein the gain and/or delay is based on the indication of the determined sweet spot location in relation to the speaker location.

8. The system of claim 1,
wherein the audio processor circuit includes a virtualizer circuit and a sweet spot adapter circuit;
wherein the sweet spot adapter circuit is configured to receive the one or more received audio signals and provide an intermediate audio output; and
wherein the virtualizer circuit is configured to receive the intermediate audio output from the sweet spot adapter circuit and generate the adjusted audio signals based on the indication of the determined sweet spot location in relation to the speaker location.

9. The system of claim 1,
wherein the audio processor circuit includes a virtualizer circuit, and wherein the virtualizer circuit is configured to receive the one or more received audio signals and apply virtualization processing to the received one or more audio signals to generate the adjusted audio signals.

10. A system for adjusting one or more received audio signals based on a listener position relative to a speaker to provide a sweet spot at the listener position in a listening environment, the system comprising:
a graphic display circuit to cause display of a sweet spot graphic at a display screen location in relation to a display screen location of a graphic representing a speaker location, based upon user input selecting the sweet spot graphic display screen location;
a sweet spot location positioning circuit to determine a sweet spot location in relation to the speaker location, based at least in part upon the speaker location and the user-selected sweet spot graphic display screen location in relation to the display screen location of the graphic representing the speaker location;
a first sensor configured to receive a first indication about one or more listener positions in a listening environment monitored by the first sensor; and
an audio processor circuit configured to generate one or more adjusted audio signals based on (1) a selected one of the one or more listener positions corresponding to the determined sweet spot location in relation to the speaker location, (2) information about a position of the speaker relative to the first sensor, and (3) the one or more received audio signals.

11. The system of claim 10, further including:
an image processor circuit coupled to the first sensor, the image processor circuit configured to select the corresponding listener position from among the one or more listener positions based upon the indication of the determined sweet spot location in relation to the speaker location.

12. The system of claim 10, further including:
an image processor circuit coupled to the first sensor, the image processor circuit configured to receive, from the first sensor, image or depth information about the listening environment including the first indication about the one or more listener positions,
wherein the image processor is configured to select a listener position from among the one or more listener positions based upon the indication of the determined sweet spot location in relation to the speaker location;
wherein the image processor circuit is configured to determine a head orientation of a listener at the selected listener position based on the received image information, the head orientation including an indication of one or more of a head yaw, head pitch, or head roll of the listener; and
wherein the audio processor circuit is configured to generate the one or more adjusted audio signals based on the indication about the selected listener position including using the determined head orientation.

13. The system of claim 12,
wherein at least one of the image processor circuit and the audio processor circuit is further configured to determine a distance parameter indicative of a distance from the speaker to each of two ears of the listener based on the indication of the one or more of the head yaw, head pitch, or head roll of the listener.

14. A method for adjusting one or more received audio signals based on user input indicating a sweet spot location relative to a speaker, the system comprising:
displaying a sweet spot graphic at a display screen location in relation to a display screen location of a graphic representing a speaker location, based upon user input selecting the sweet spot graphic display screen location;
determining a sweet spot location in relation to the speaker location, based at least in part upon the speaker location and the user-selected sweet spot graphic display screen location in relation to the display screen location of the graphic representing the speaker location; and
generating, using an audio processor circuit, one or more adjusted audio signals based at least in part upon the one or more received audio signals, an indication of the determined sweet spot location in relation to the speaker location.

15. The method of claim 14 further including:
displaying at the display screen, a distance graphic indicating a user selected distance; and
wherein determining includes determining the sweet spot location in relation to the speaker location, based at least in part upon both the physical speaker location and the user-selected sweet spot graphic display screen location in relation to the display screen location of the graphic representing a speaker location.

16. The method of claim 14 further including:
displaying at the display screen, a graphic representing a range of user selectable sweet spot graphic locations in relation to the display screen location of the graphic representing the speaker location.

17. The method of claim 14 further including:
displaying at the display screen, a graphic representing a range of user selectable sweet spot graphic locations at different distances on the display screen from the display screen location of the graphic representing the speaker location.

18. A method for adjusting one or more received audio signals based on a listener position relative to a speaker to provide a sweet spot at the listener position in a listening environment, the method comprising:
displaying a sweet spot graphic at a display screen location in relation to a display screen location of a graphic representing a speaker location, based upon user input selecting the sweet spot graphic display screen location;
determining a sweet spot location in relation to the speaker location, based at least in part upon the speaker location and the user-selected sweet spot graphic display screen location in relation to the display screen location of the graphic representing the speaker location;
receiving a first indication from a first sensor about one or more listener positions in a listening environment monitored by the first sensor; and
generating one or more adjusted audio signals based on (1) a selected one of the received first indication about one or more listener positions from the first sensor selected based upon the determined sweet spot location in relation to the speaker location, (2) information about a position of the speaker relative to the first sensor, and (3) the one or more received audio signals.

19. The method of claim 18 selecting using an image processing circuit, a listener position from among the one or more listener positions based upon the indication of the determined sweet spot location in relation to the speaker location;
determining, using the image processing circuit, a head orientation of a listener at the selected listener position based on the received image information, the head orientation including an indication of one or more of a head yaw, head pitch, or head roll of the listener; and
wherein generating the one or more adjusted audio signals includes generating based on the indication about the selected listener position including using the determined head orientation.

20. The method of claim 18 further including:
determining, using the image processing circuit, a distance parameter indicative of a distance from the speaker to each of two ears of the listener based on the indication of the one or more of the head yaw, head pitch, or head roll of the listener.
